(19) United States
(12) Patent Application Publication
(10) Pub. No.: US 2013/0163793 A1
(43) Pub. Date: Jun. 27, 2013

(54) VIBRATION SPEAKER WITH A SECURING DEVICE

(71) Applicants: Chien-Chang Chen, Taoyuan County (TW); Chien-Hsuan Yen, New Taipei City (TW)

(72) Inventors: Chien-Chang Chen, Taoyuan County (TW); Chien-Hsuan Yen, New Taipei City (TW)

(73) Assignee: CHIEF LAND ELECTRONIC CO., LTD., NEW TAIPEI CITY (TW)

(21) Appl. No.: 13/366,304

(22) Filed: Feb. 4, 2012

(30) Foreign Application Priority Data
Dec. 27, 2011 (TW) 100224694

(51) Int. Cl. H04R 1/00; H04R 17/00

(52) U.S. Cl. 381/190; 381/191

(57) ABSTRACT

The present invention is directed to a vibration speaker with a securing device. The vibration speaker includes a transducer, and a bottom having at least one groove. At least one fastening element corresponding to the at least one groove is capable of being inserted into the groove. The transducer is driven to generate vibration, which is then transferred to a vibration plate via the fastening element.

### CROSS-REFERENCE TO RELATED APPLICATIONS

The entire contents of Taiwan Patent Application No. 100224694, filed on Dec. 27, 2011, from which this application claims priority, are incorporated. herein by reference.

### BACKGROUND OF THE INVENTION

1. Field of the Invention

The present invention generally relates to a vibration speaker, and more particularly to a vibration speaker with a securing device.

2. Description of Related Art

A speaker (or “loudspeaker”) is a transducer that transforms an electrical signal to mechanical vibration. A conventional moving-coil speaker is made up of a magnet, a voice coil, a flexible support and a sound releasing hole. In operation, the electrical signal is transferred to the voice coil, which produces electromagnetic induction, therefore generating an induced current. The induced current energizes the flexible support, and sound is thus produced via the sound releasing hole. in spite of the fact that the conventional moving--coil speaker has been fully developed, it nevertheless occupies large volume, consumes great power and is liable to magnetic field. Therefore, the conventional moving-coil speaker is not adaptable to miniaturization or portability for electronic devices.

In order to overcome the disadvantages mentioned above, a vibration speaker is thus proposed. The vibration speaker produces sound according to acoustic resonance by propagating the generated vibration energy to a vibration plate that is in contact with the vibration speaker.

A conventional vibration speaker makes contact with the vibration plate by way of its weight, or forms a bond with the vibration plate via an adhesive element that is fixed to the vibration speaker. However, a single adhesive element cannot be adapted to diverse vibration plates with varieties of materials (e.g., wood, glass or metal), smoothness and roughness. Further, as the adhesive element oftentimes cannot be replaced with ease, its binding force dramatically decreases due to contamination after a couple of uses, therefore leading to ineffectiveness in secureness of the vibration. speaker and cutting down the convenience provided by the vibration speaker.

Therefore, a need has arisen to propose a novel vibration speaker with a securing device to overcome the drawbacks discussed above.

### SUMMARY OF THE INVENTION

In view of the foregoing, the embodiment of the present invention provides a vibration speaker with a securing device, to which a user may flexibly alter the material and configuration of fastening elements according to characteristics of the vibration plate. Accordingly, the vibration speaker may adaptively match diverse vibration plates, and effectiveness in secureness between the vibration speaker and the vibration plate may be greatly enhanced.

According to one embodiment, a vibration speaker includes at least one transducer, a bottom and at least one fastening element. The bottom has at least one groove. The fastening elements correspond to the grooves, and are capable of being inserted into the corresponding grooves. The transducer is driven to generate vibration, which is then transferred to a vibration plate via the fastening element.

### BRIEF DESCRIPTION OF THE DRAWINGS

FIG. 1 shows a perspective view of a vibration speaker with a securing device according to one embodiment of the present invention;

FIG. 2A shows a bottom perspective view of the vibration speaker of FIG. 1;

FIG. 2B shows a partial cross section of the fastening element being inserted, into the groove;

FIG. 3A to FIG. 31D show bottom views of varieties of grooves of the vibration speaker according to the embodiment of the present invention; and

FIG. 4A to FIG. 4C show cross-sectional views of varieties of grooves of the vibration speaker according to the embodiment of the present invention.

### DETAILED DESCRIPTION OF THE INVENTION

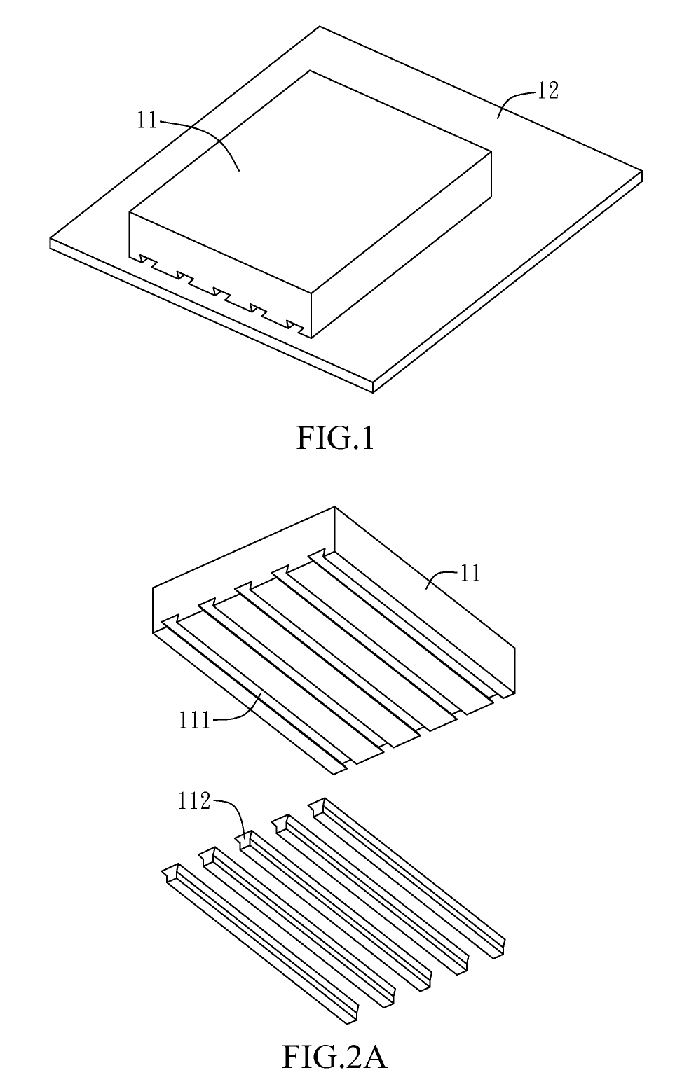

FIG. 1 shows a perspective view of a vibration speaker 11 with a securing device according to one embodiment of the present invention. In the embodiment, the vibration speaker 11 includes a vibration module and a driving module. The driving module receives an electrical signal, according to which a proper driving signal is generated and is used to drive the vibration module, therefore resulting in mechanical vibration. When a bottom of the vibration speaker 11 (or the vibration module) is in contact with a vibration plate 12 (e.g., a piece of glass, a desktop, or a wall), the mechanical vibration is then transferred to the vibration plate 12, thereby producing sound wave perceptible by a user. The vibration module of the embodiment includes at least one transducer, which is made up of a piezoelectric material, an electro-active polymer (EAP), a shape memory alloy (SMA), a magnetostrictive material, an electrostrictive material, a voice coil motor, an eccentric rotating mass (ERM) motor or a linear resonant actuator (LRA).

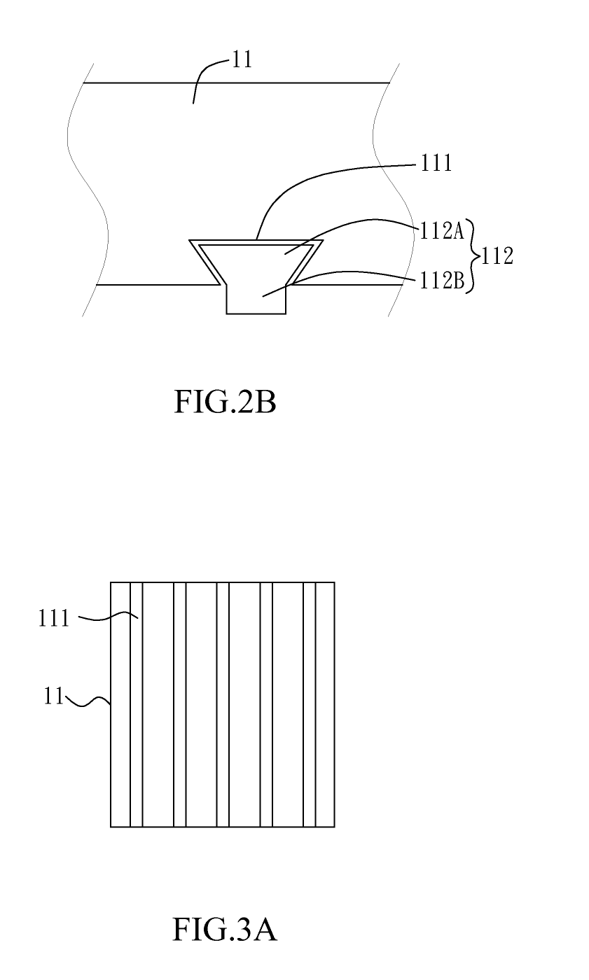

FIG. 2A shows a bottom perspective view of the vibration speaker 11 of FIG. 1. In the embodiment, the bottom of the vibration speaker 11 has at least one groove 111. Further, the embodiment includes at least one fastening element 112 corresponding to the at least one groove 111. The fastening element 112 is capable of being inserted into the groove 111. The groove 111 and the fastening element 112 mentioned above together form a securing device, particularly a replaceable securing device, of the vibration speaker 11.

FIG. 2B shows a partial cross section of the fastening element 112 being inserted. into the groove 111. As shown in the figure, the fastening element 112 includes an inserting portion. 112A and a fastening portion 112B. The inserting portion 112A is capable of being inserted inside the groove 111, and the fastening portion 112B is disposed outside the groove 111. The fastening portion 112B of the embodiment includes a fastening material for being fastened to the vibration plate 12, such that the vibration speaker 11 can be secured to the vibration plate 12. The fastening material may be, for example, an adhesive (e.g., polyurethane adhesive or PU adhesive), clay or a magnet.

In one embodiment, the fastening elements 112 need not be made up of the same fastening material. In other words, the fastening elements 112 of the securing device of the embodiment may respectively select different fastening materials to result in a combinatory securing device, which may adaptively match diverse vibration plates with varieties of materials, smoothness and roughness to arrive at a better effectiveness in securing the vibration speaker 11. For example, with respect to a metal vibration plate 12, the fastening elements 112 either may all be made up of the magnet, or may partially be made up of the magnet and partially be made up of the adhesive. With respect to a non-metal vibration plate 12, the fastening elements 112 may all be made up of the adhesive.

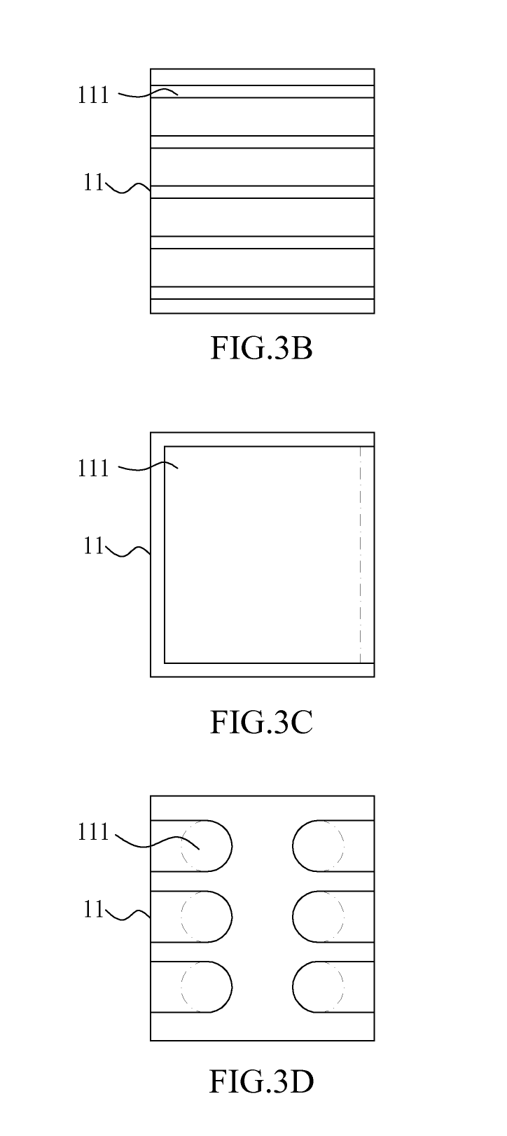

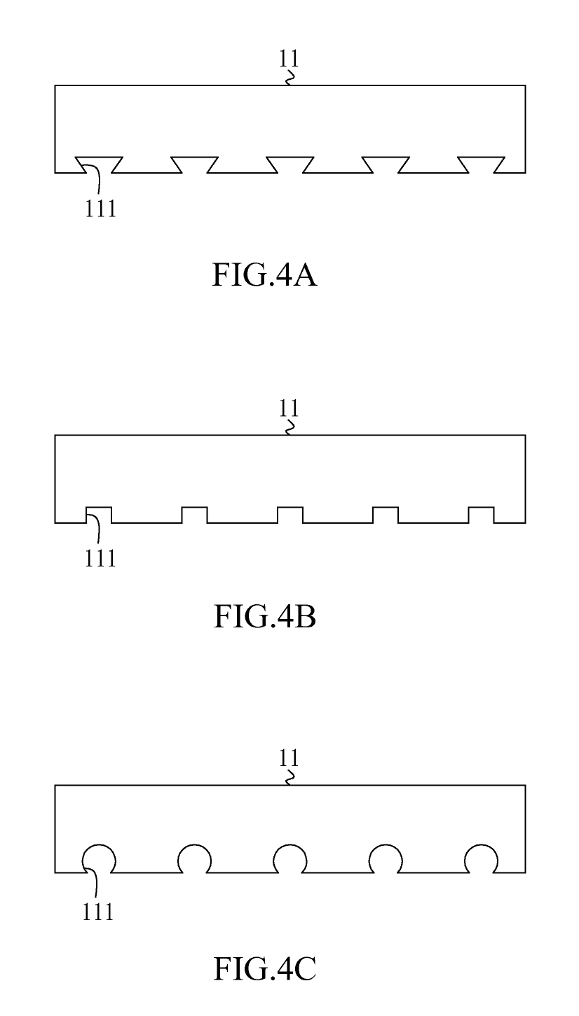

The groove 111 of the vibration speaker 11 in the embodiment may have a shape other than that shown in FIG. 2A. FIG. 3A to FIG. 3D show bottom views of varieties of grooves 111 of the vibration speaker 11 according to the embodiment of the present invention. Specifically, FIG. 3A shows the grooves 111 of a (longitudinal) bar shape, FIG. 3B shows the grooves 111 of a (lateral) bar shape, FIG. 3C shows the grooves 111 of a block shape, and FIG. 3D shows the grooves 111 of a circular shape. As illustrated in FIG. 3C, an opening extends from the block-shape groove 111 to an edge of the bottom of the vibration speaker 11. The extended opening facilitates inserting the fastening element 112 to the groove 111 or removing the fastening element 112 from the groove 111. Similarly, as illustrated in FIG. 3D, openings extend from the circular grooves 111 to the edges of the bottom of the vibration speaker 11. FIG. 4A to FIG. 4C show cross-sectional views of varieties of grooves 111 of the vibration speaker 11 according to the embodiment of the present invention. Specifically, FIG. 4A shows the grooves 111 with a trapezoidal cross section, FIG. 4B shows the grooves 111 with a rectangular cross section, and FIG. 40 shows the grooves 111 with a semi-circular cross section. In the embodiment, the inserting portion 112A of the fastening element 112 has a shape and cross section complementary to the shape and cross section of the groove 111, as shown in FIGS. 3A-3D and FIGS. 4A-4C.

In one embodiment, the grooves 111 or the fastening elements 112 need not have the same shape. In other words, the grooves 111 or the fastening elements 112 of the embodiment may respectively select different shapes and configurations to adaptively match characteristics of the vibration plate 12.

Although specific embodiments have been illustrated and described, it will be appreciated by those skilled in the art that various modifications may be made without departing from the scope of the present invention, which is intended to be limited solely by the appended claims.

What is claimed is:

1. A vibration speaker with a securing device, comprising:
at least one transducer;
a bottom having at least one groove; and
at least one fastening element, corresponding to the at least one groove, being capable of being inserted into the corresponding groove;
wherein the transducer is driven to generate vibration, which is then transferred to a vibration plate via the fastening element.

2. The vibration speaker with the securing device of claim wherein the vibration speaker comprises:
a vibration module having the transducer disposed therein; and
a driving module configured to receive an electrical signal, according to which a driving signal is generated and is used to drive the transducer of the vibration module.

3. The vibration speaker with the securing device of claim 1, wherein the transducer comprises a piezoelectric material, an electro-active polymer (EAP), a shape memory alloy (SMA), a magnetostrictive material, an electrostrictive material, a voice coil motor, an eccentric rotating mass (ERM) motor or a linear resonant actuator (LRA).

4. The vibration speaker with the securing device of claim 1, wherein, the fastening element comprises an. inserting portion and a fastening portion, wherein the inserting portion is capable of being inserted inside the groove, and the fastening portion is disposed outside the groove.

5. The vibration speaker with the securing device of claim 4, wherein the fastening portion comprises a fastening material for being fastened to the vibration plate.

6. The vibration speaker with the securing device of claim 5, wherein, the fastening portion comprises an adhesive, clay or a magnet.

7. The vibration speaker with the securing device of claim 1, wherein the groove is of a bar shape, a block shape or a circular shape.

8. The vibration speaker with the securing device of claim 1, wherein the groove has a trapezoidal cross section, a rectangular cross section or a semi-circular cross section.

9. The vibration speaker with the securing device of claim 4, wherein the groove has a shape complementary to a shape of the inserting portion of the fastening element.
